(19) United States
(12) Patent Application Publication
(10) Pub. No.: US 2024/0310983 A1
(43) Pub. Date: Sep. 19, 2024

(54) INFORMATION PROCESSING SYSTEM, NON-TRANSITORY COMPUTER READABLE MEDIUM, AND INFORMATION PROCESSING METHOD

(71) Applicant: FUJIFILM BUSINESS INNOVATION CORP., Tokyo (JP)

(72) Inventor: Kazuma NOGAMI, Kanagawa (JP)

(73) Assignee: FUJIFILM BUSINESS INNOVATION CORP., Tokyo (JP)

(21) Appl. No.: 18/364,283

(22) Filed: Aug. 2, 2023

(30) Foreign Application Priority Data
Mar. 13, 2023 (JP) 2023-038488

(51) Int. Cl. G06F 3/04845; G06F 3/0482

(52) U.S. Cl. CPC G06F 3/04845; G06F 3/0482

(57) ABSTRACT

An information processing system includes one or multiple processors configured to: cause a terminal for operating an image processing apparatus to display one or more functions provided by the image processing apparatus in a selectable manner; acquire, from the image processing apparatus, configuration information on configuration for performing an operation to utilize a function with the terminal, the function being selected by a user from the displayed one or more functions; and generate elements of user interface to be displayed on the terminal, based on the acquired configuration information.

### CROSS-REFERENCE TO RELATED APPLICATIONS

This application is based on and claims priority under 35 USC 119 from Japanese Patent Application No. 2023-038488 filed Mar. 13, 2023.

### BACKGROUND

### (i) Technical Field

The present disclosure relates to an information processing system, a non-transitory computer readable medium, and an information processing method.

### (ii) Related Art

There is a known technique (for example, Japanese Unexamined Patent Application Publication No. 2013-027029) that assists in performing an operation on an image processing apparatus, such as a so-called multifunction printer that enables printing and reading of a document, the operation being performed with a mobile terminal in which dedicated application software is installed.

### SUMMARY

With such a technique, when a new function is added to an image processing apparatus, a provider of dedicated application software is required to distribute update data to handle the new added function, and a user is required to obtain the distributed update data and perform an updating operation on the dedicated application software installed in a mobile terminal. Thus, even though a new function is added to the image processing apparatus, it may be difficult to perform an operation for utilizing the function with the mobile terminal depending on the timing when distribution of the update data is started and the timing of an updating operation performed by a user.

Aspects of non-limiting embodiments of the present disclosure relate to an information processing system that, upon addition of a new function to an image processing apparatus operated by a user using a mobile terminal, enables an operation to utilize the function with the mobile terminal without obtaining corresponding update data from a website or the like.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or a plurality of processors configured to: cause a terminal for operating an image processing apparatus to display one or more functions provided by the image processing apparatus in a selectable manner; acquire, from the image processing apparatus, configuration information on configuration for performing an operation to utilize a function with the terminal, the function being selected by a user from the displayed one or more functions; and generate elements of user interface to be displayed on the terminal, based on the acquired configuration information.

### BRIEF DESCRIPTION OF THE DRAWINGS

Exemplary embodiment of the present disclosure will be described in detail based on the following figures, wherein:

FIG. 1 is a diagram illustrating an example of the entire configuration of an information processing system to which the exemplary embodiment is applied;

FIG. 2 is a diagram illustrating an example of a hardware configuration of a management server;

FIG. 3 is a diagram illustrating an example of a hardware configuration of an image processing apparatus;

FIG. 4 is a diagram illustrating an example of a functional configuration of a controller of the management server;

FIG. 5 is a diagram illustrating an example of a functional configuration of a controller of a user terminal;

FIG. 6 is a diagram illustrating an example of a functional configuration of a controller of the image processing apparatus;

FIG. 7 is a flowchart illustrating an example of a process flow of the management server;

FIGS. 8A to 8C are views illustrating specific examples of a user interface displayed on a user terminal, FIG. 8A is a view illustrating a specific example of a top screen to be displayed when an application software that enables an operation of the image processing apparatus is started, and FIGS. 8B and 8C are views illustrating a specific example of a screen to be displayed when an additional function button displayed on the screen of FIG. 8A is depressed;

FIGS. 9A to 9C are views illustrating specific examples of a generated UI element table and user interface, FIG. 9A is a view illustrating a specific example of information stored in the UI element table, FIG. 9B is a view illustrating a specific example of user interface which reflects the information stored in the UI element table, and FIG. 9C is a view illustrating a state after a custom button is added to the top screen; and

FIGS. 10A to 10D are views illustrating specific examples of a function table, FIG. 10A is a view illustrating a specific example of information stored in the function table, and FIGS. 10B to 10D are views illustrating displayed top screens which vary with the type of a selected image processing apparatus.

### DETAILED DESCRIPTION

Hereinafter, an exemplary embodiment of the present disclosure will be described in detail with reference to the accompanying drawings.

### <Entire Configuration of Information Processing System>

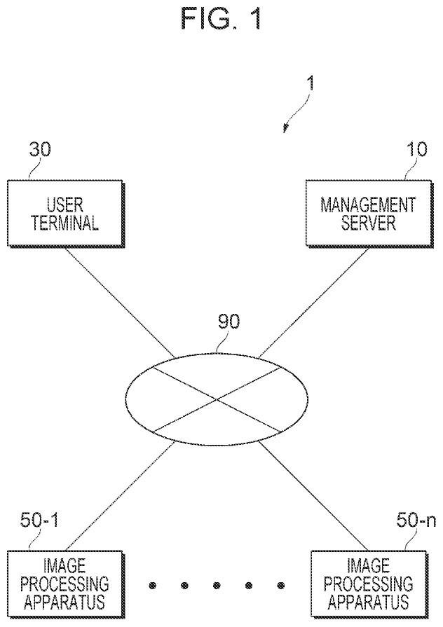

FIG. 1 is a diagram illustrating an example of the entire configuration of an information processing system 1 to which the exemplary embodiment is applied.

The information processing system 1 is formed by connecting a management server 10, a user terminal 30, and image processing apparatuses 50-1 to 50-n (n is an integer value greater than or equal to one) to each other via a network 90. For example, the network 90 is a local area network (LAN), or the Internet. Note that when the image processing apparatuses 50-1 to 50-n do not need to be individually described, these are collectively referred to as the image processing apparatus 50.

### (Management Server)

The management server 10 included in the information processing system 1 is an information processing apparatus as a server that manages the information processing system 1 in its entirety. The management server 10 performs: a process of obtaining various information transmitted from the user terminal 30, the image processing apparatus 50, and the outside; various processes for the obtained various information; and a process of transmitting the various information to the user terminal 30, the image processing apparatus 50, and the outside.

For example, the management server 10 can obtain information (hereinafter referred to as “functional information”) on one or more functions provided by each of the image processing apparatuses 50-1 to 50-n, and stores and manages the obtained functional information in a database. The management server 10 retrieves, from the database, the functional information of an image processing apparatus 50 specified by a user from the image processing apparatuses 50-1 to 50-n, and displays, on the user terminal 30, the one or more functions provided by the image processing apparatus 50 in a selectable manner.

When one function is selected as an additional function from the one or more functions provided by the image processing apparatus 50 displayed on the user terminal 30, the management server 10 obtains information (hereinafter referred to as “configuration information”) on configuration for performing an operation of utilizing the function with the user terminal 30. The configuration information is individually managed by each of the image processing apparatuses 50-1 to 50-n, thus obtained from the image processing apparatus 50.

The “additional function” refers to a function to be added to the functions such as, printing, copying, and reading, basically provided by the image processing apparatus 50. For example, a function of performing facsimile (FAX) transmission of an image formed on a sheet of paper to a specific destination immediately after the image is read is an example of an additional function. As the configuration for performing an operation of utilizing an additional function with the user terminal 30, the “configuration information” includes, for example, the arrangement, operation, and instructions of user interface.

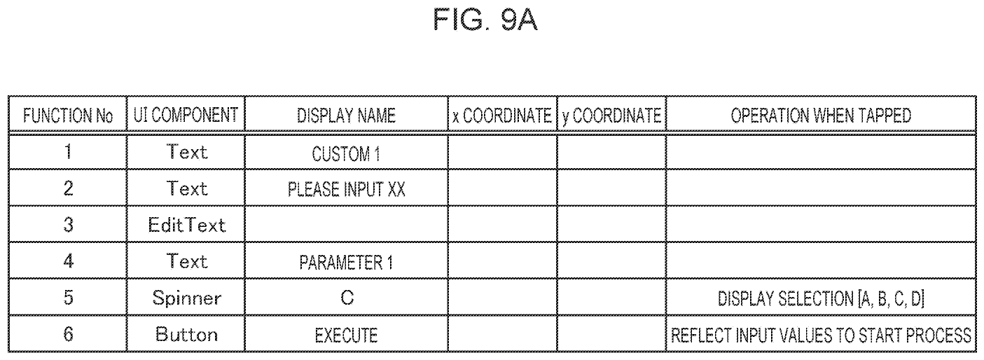

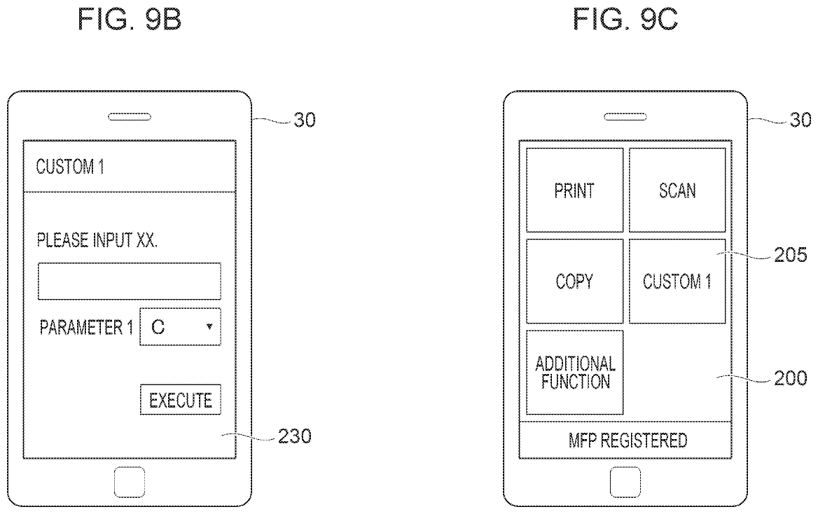

In addition, the management server 10 generates the elements of user interface displayed on the user terminal 30 based on the configuration information obtained from the image processing apparatus 50. The management server 10 generates a table (hereinafter referred to as an “UI element table”) for defining the elements of user interface displayed on the user terminal 30 based on the obtained configuration information. The management server 10 manages the aspects of the elements of user interface displayed on the user terminal 30 using the UI element table generated. Note that a specific example of the UI element table will be described below with reference to FIG. 9A.

The management server 10 manages the image processing apparatus 50 specified by a user, and generated elements of user interface in association with each other. When the image processing apparatus 50 is specified again by a user, the management server 10 displays, on the user terminal 30, the elements of user interface associated with the image processing apparatus 50.

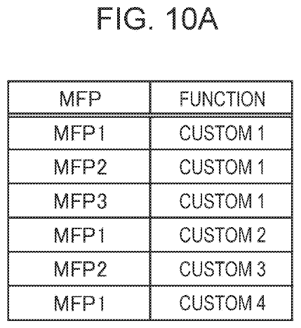

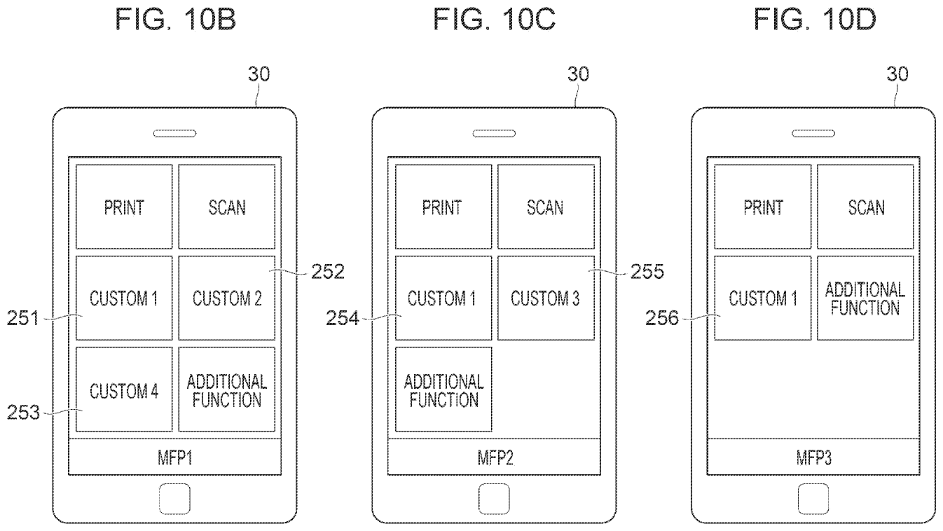

In addition, the management server 10 generates a table (hereinafter referred to as a “function table”) that associates the image processing apparatus 50 specified by a user with an additional function selected by the user. The management server 10 stores the generated function table in the user terminal 30. Note that a specific example of a function table will be described below with reference to FIG. 10A. The details of the process performed by the management server 10 will be described below.

### (User Terminal)

The user terminal 30 is an information processing apparatus, such as a smartphone, a tablet terminal, or a personal computer, operated by a user who utilizes the information processing system 1. Application software to enable the operation of the image processing apparatus 50 is installed in the user terminal 30. The user terminal 30 obtains various information transmitted from the management server 10, and performs various processes. The user terminal 30 transmits various information to the management server 10.

For example, the user terminal 30 receives an input operation for specifying an image processing apparatus 50. For example, as an input operation for specifying an image processing apparatus 50, the user terminal 30 receives an operation of inputting identification information by which the image processing apparatus 50 is uniquely identifiable. Here, the “identification information” includes, for example, an IP address and a port number.

In addition, the user terminal 30 receives an input operation for selecting one of one or more functions provided by the image processing apparatus 50. For example, the user terminal 30 receives an input operation for selecting a newly added function from the one or more functions provided by the image processing apparatus 50.

In addition, the user terminal 30 stores the above-mentioned function table in which an image processing apparatus 50 specified by a user is associated with a function selected by the user. The user terminal 30 then retrieves, from the function table, one or more functions associated with the image processing apparatus 50 specified by a user, and displays the elements of user interface corresponding to each of the retrieved one or more functions. Note that the details of the process of the user terminal 30 will be described below.

### (Image Processing Apparatus)

The image processing apparatus 50 performs various processes according to an input operation of a user who utilizes the information processing system 1. For example, the image processing apparatus 50 performs: a process of forming an image on a medium such as a sheet of paper; a process of outputting a recording medium with an image formed; and a process of reading the image formed on the sheet of paper. As the image processing apparatus 50, for example, a so-called electrophotographic multifunction printer that forms a toner image on the printing surface of a sheet of paper, and a so-called ink-jet printer that ejects ink to the printing surface of a sheet of paper may be mentioned.

In addition, the image processing apparatus 50 obtains various information transmitted from the management server 10 and the user terminal 30, and performs various processes. The image processing apparatus 50 also transmits various information to the management server 10 and the user terminal 30. For example, the image processing apparatus 50 stores and manages the functional information of the apparatus. The image processing apparatus 50 manages the configuration information on the functions added to the apparatus.

For an inquiry from the management server 10 regarding the provision of the functional information of the apparatus, the image processing apparatus 50 provides the functional information of the apparatus. For an inquiry from the management server 10 regarding the provision of the configuration information on the functions added to the apparatus, the image processing apparatus 50 provides the configuration information. Note that the details of the process of the image processing apparatus 50 will be described below.

The above-described configuration of the information processing system 1 is an example, and may include the functions to implement the above-described processes as the entire information processing system 1. Thus, part or all of the functions to implement the above-described processes may be shared or may be handled in a collaborative manner in the information processing system 1. Specifically, part or all of the functions of the management server 10 may be functions of the user terminal 30 or the image processing apparatus 50, or part or all of the functions of the user terminal 30 may be functions of the management server 10 or the image processing apparatus 50. Alternatively, part or all of the functions of the image processing apparatus 50 may be functions of the management server 10 or the user terminal 30. Furthermore, part or all of the functions of each of the management server 10, the user terminal 30, and the image processing apparatus 50 included in the information processing system 1 may be transferred to another server which is not illustrated. Thus, the process as the entire information processing system 1 is promoted, and the processes can be supplemented.

### (Hardware Configuration of Management Server)

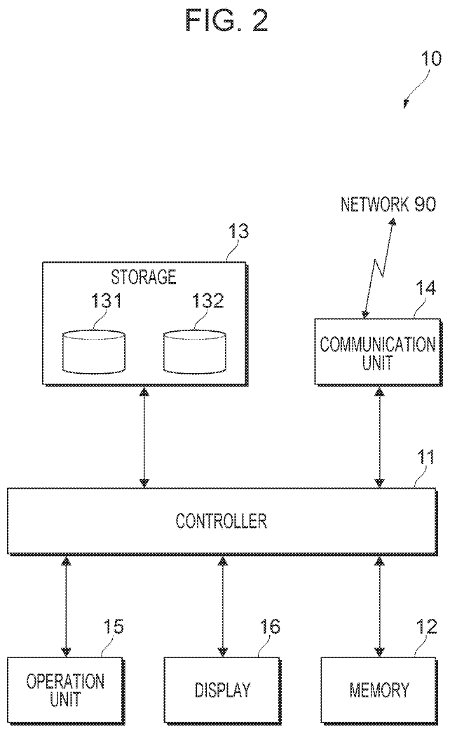

FIG. 2 is a diagram illustrating an example of the hardware configuration of the management server 10.

The management server 10 has a controller 11, a memory 12, a storage 13, a communication unit 14, an operation unit 15, and a display 16. These components are connected by a data bus, an address bus, a peripheral component interconnect (PCI) bus.

The controller 11 is a processor that controls the function of the management server 10 through execution of various software such as OS (basic software) and application software (applied software). For example, the controller 11 is comprised of a central processing unit (CPU). The memory 12 is a storage area to store various software and data used for execution of the software, and is used as a work area when calculation is performed. The memory 12 is comprised of, for example, a random access memory (RAM).

The storage 13 is a storage area to store input data to various software and output data from various software. The storage 13 is comprised of, for example, a hard disk drive (HDD), a solid state drive (SSD), and a semiconductor memory which are used to store programs and various setting data. As a database to store various information, the storage 13 stores, for example, a functional DB 131 that stores functional information, and a configuration DB 132 that stores configuration information.

The communication unit 14 transmits and receives data between the user terminal 30 and the outside via the network 90. The operation unit 15 is comprised of, for example, a keyboard, a mouse, and mechanical buttons, switches, and receives an input operation. The operation unit 15 also includes a touch sensor that forms a touch panel integrally with the display 16. The display 16 is comprised of, for example, a liquid crystal display or an organic electro luminescence (EL) display used to display information, and displays data of image and text.

### (Hardware Configuration of User Terminal)

The hardware configuration of the user terminal 30 has the same configuration as the hardware configuration of the management server 10 illustrated in FIG. 2. Specifically, the user terminal 30 includes a controller, a memory, a storage, a communication unit, an operation unit, and a display that have the same functions as those of the controller 11, the memory 12, the storage 13, the communication unit 14, the operation unit 15, and the display 16 in FIG. 2, thus Illustration and description are omitted.

### (Hardware Configuration of Image Processing Apparatus)

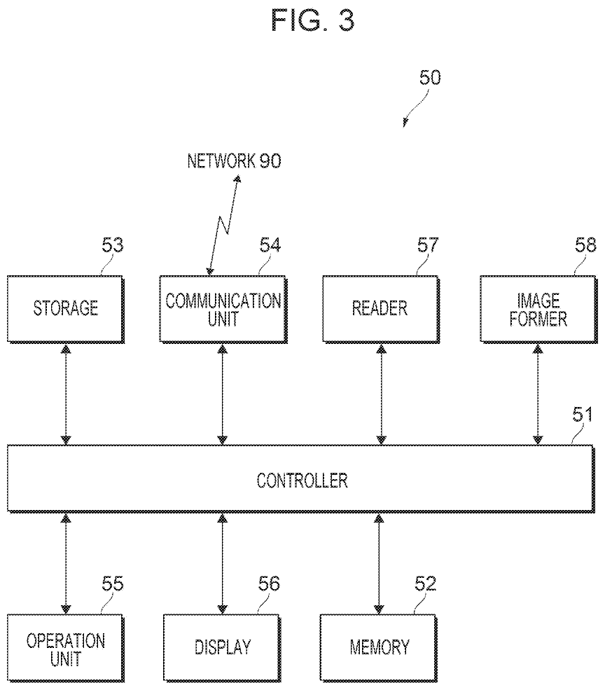

FIG. 3 is a diagram illustrating an example of the hardware configuration of the image processing apparatus 50.

The image processing apparatus 50 has the hardware configuration corresponding to the controller 11, the memory 12, the storage 13, the communication unit 14, the operation unit 15, and the display 16 in the hardware configuration of the management server 10 of FIG. 2.

Specifically, the image processing apparatus 50 has a controller 51 comprised of a processor such as a CPU, a memory 52 comprised of a storage area such as a RAM, and a storage 53 comprised of a storage area such as an HDD, an SDD, and a semiconductor memory. The storage 53 stores a database that stores various information. In addition, the image processing apparatus 50 has a communication unit 54 that transmits and receives data between the management server 10, the user terminal 30, and the outside via the network 90. The image processing apparatus 50 also has an operation unit 55 comprised of a touch panel or the like, and a display 56 comprised of a liquid crystal display or an organic EL display.

Furthermore, in addition to this configuration, the image processing apparatus 50 has a reader 57, and an image former 58. The reader 57 reads an image recorded on a medium (for example, a paper medium document) such as a sheet of paper as a recording medium. The reader 57 is comprised of, for example, a CCD scanner that reduces reflected light of light by a lens after radiating the light from a light source to a document, and receives the reduced light by a charge coupled device (CCD), or a CIS scanner that receives reflected light of light sequentially radiated from an LED light source to a document by a contact image sensor (CIS). The image former 58 forms an image of an object to be printed on the printing surface of a sheet of paper as a recording medium, for example, by an electrophotographic system or an ink-jet system. These components are connected by a data bus, an address bus, or a PCI bus.

### (Functional Configuration of Controller of Management Server)

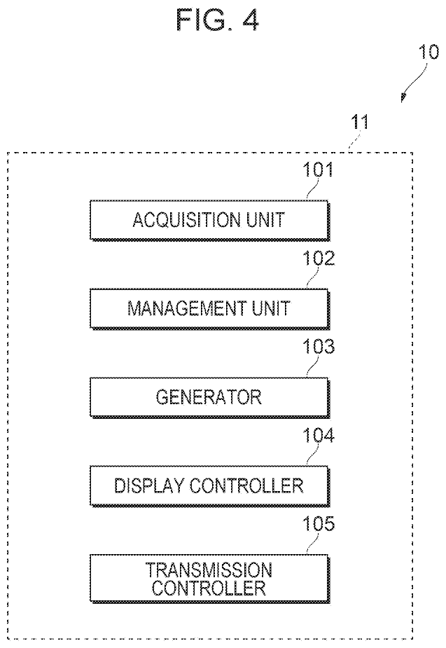

FIG. 4 is a diagram illustrating an example of the functional configuration of the controller 11 of the management server 10.

An acquisition unit 101, a management unit 102, a generator 103, a display controller 104, and a transmission controller 105 function in the controller 11 of the management server 10.

The acquisition unit 101 acquires various information. Specifically, the acquisition unit 101 acquires various information transmitted from each of the user terminal 30, the image processing apparatus 50, and the outside. Of the information acquired by the acquisition unit 101, the information transmitted from the user terminal 30 includes, for example, input information input by an operation of a user. Of the information acquired by the acquisition unit 101, the information transmitted from the image processing apparatus 50 includes, for example, functional information, and configuration information.

The management unit 102 stores and manages various information in the database of the storage 13 (see FIG. 2). For example, the management unit 102 stores and manages the functional information of each of the image processing apparatuses 50-1 to 50-n in the functional DB 131. In addition, the management unit 102 stores and manages the configuration information in the configuration DB 132. The functional information and the configuration information are associated with each other.

For example, the management unit 102 retrieves the functional information of an image processing apparatus 50 specified by a user from the database. Specifically, the management unit 102 identifies the image processing apparatus 50 from input information for specifying the image processing apparatus 50, the input information being acquired by the acquisition unit 101, and retrieves the functional information of the image processing apparatus 50 from the functional DB 131.

In addition, the management unit 102 uses a UI element table generated by the later-described generator 103 to manage the aspects of the elements of user interface displayed on the user terminal 30. The management unit 102 also manages the image processing apparatus 50 specified by a user, and the elements of user interface generated by the later-described generator 103 in association with each other.

The generator 103 generates the elements of user interface displayed on the user terminal 30 based on the configuration information acquired from the image processing apparatus 50. The “elements of user interface” include: the function icons to be operated by a user who utilizes the function of the image processing apparatus 50; a user interface displayed as a result of an operation on the function icons; and text data, spinner, and buttons that form the user interface.

The generator 103 generates a UI element table based on the configuration information acquired from the image processing apparatus 50. The UI element table includes, for example, information on each of type, label, arrangement, and operation for each of the elements of user interface displayed on the user terminal 30. In addition, the generator 103 generates a function table that associates an image processing apparatus 50 specified by a user with an additional function selected by the user.

The display controller 104 performs control to cause the display 56 of the user terminal 30 to display various information. Specifically, the display controller 104 transmits control information for displaying various information to the user terminal 30. For example, the display controller 104 transmits, to the user terminal 30, control information for displaying one or more functions of the image processing apparatus 50 in a selectable manner, the one or more functions being identified from the functional information retrieved based on the input information of a user.

The transmission controller 105 controls transmission of various information. Specifically, the transmission controller 105 controls transmission of various information to each of the user terminal 30, the image processing apparatus 50 and the outside. Of the information for which transmission is controlled by the transmission controller 105, the information transmitted to the user terminal 30 includes, for example, a function table, and control information for displaying one or more functions of the image processing apparatus 50 in a selectable manner. Of the information for which transmission is controlled by the transmission controller 105, the information transmitted to the image processing apparatus 50 includes, for example, information on inquiry of provision of functional information, information on inquiry of provision of configuration information on added function, and information which has been input to execute the process of the image processing apparatus 50.

### (User Terminal)

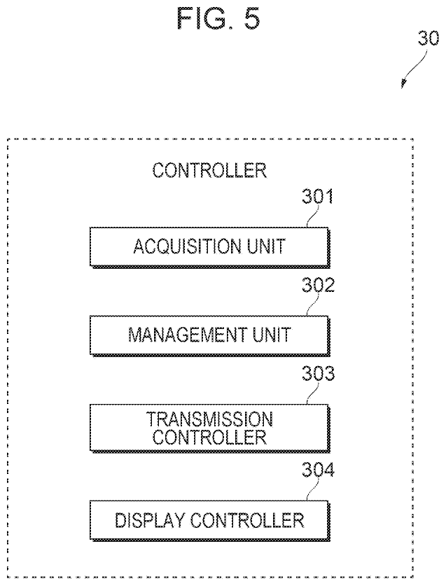

FIG. 5 is a diagram illustrating an example of the functional configuration of the controller of the user terminal 30.

An acquisition unit 301, a management unit 302, a transmission controller 303, and a display controller 304 function in the controller of the user terminal 30.

The acquisition unit 301 acquires various information. Specifically, the acquisition unit 301 acquires input information which has been received by the operation unit. For example, the acquisition unit 301 acquires input information which has been input to specify an image processing apparatus 50. In addition, the acquisition unit 301 acquires input information which has been input to specify one function as an additional function among one or more functions provided by the image processing apparatus 50.

In addition, the acquisition unit 301 acquires various information transmitted from the management server 10, the image processing apparatus 50, and the outside. Of the information acquired by the acquisition unit 301, the information transmitted from the management server 10 includes, for example, a function table, and control information for displaying various information on the display.

The management unit 302 stores and manages various information in the storage. For example, the management unit 302 stores and manages a function table.

The transmission controller 303 controls transmission of various information via the communication unit. Specifically, the transmission controller 303 controls transmission of various information to the management server 10, the image processing apparatus 50, and the outside. Of the information for which transmission is controlled by the transmission controller 303, the information transmitted to the management server 10 includes, for example, input information input by an operation of a user.

The display controller 304 performs control for displaying various information on the display. For example, the display controller 304 performs control for displaying information in a selectable manner, the information indicating one or more image processing apparatuses 50 operable with the user terminal 30. In addition, the display controller 304 performs control for displaying information in a selectable manner, the information indicating one or more functions provided by an image processing apparatus 50 specified by a user. In addition, the display controller 304 performs control for displaying, on the user terminal 30, the elements of user interface associated with an image processing apparatus 50 specified by a user.

### (Functional Configuration of Controller of Image Processing Apparatus)

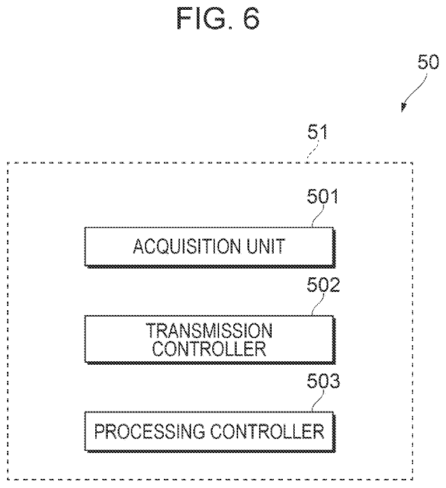

FIG. 6 is a diagram illustrating an example of the functional configuration of the controller 51 of the image processing apparatus 50.

An acquisition unit 501, a transmission controller 502, and a processing controller 503 function in the controller 51 of the image processing apparatus 50.

The acquisition unit 501 acquires various information. Specifically, the acquisition unit 501 acquires input information which has been received by the operation unit 55 (see FIG. 3). For example, the acquisition unit 501 acquires input information which has been input to execute various processes. In addition, the acquisition unit 501 acquires various information transmitted from the management server 10, the user terminal 30, and the outside. Of the information acquired by the acquisition unit 501, the information transmitted from the management server 10 includes, for example, information on inquiry of provision of functional information, information on inquiry of provision of configuration information on added function, and information which has been input to execute the process of the image processing apparatus 50.

The transmission controller 502 controls transmission of various information via the communication unit 54 (see FIG. 3). Specifically, the transmission controller 502 controls transmission of various information to the management server 10, the user terminal 30, and the outside. Of the information for which transmission is controlled by the transmission controller 502, the information transmitted to the management server 10 includes, for example, functional information of the image processing apparatus 50, and configuration information of a function added to the image processing apparatus 50.

The processing controller 503 performs control to cause the communication unit 54, the reader 57, and the image former 58 (see FIG. 3) to execute various processes related to the functions of the image processing apparatus 50 based on the information which has been transmitted from the management server 10 and inputted to execute the process of the image processing apparatus 50.

### <Process Flow>

### (Process Flow of Management Server)

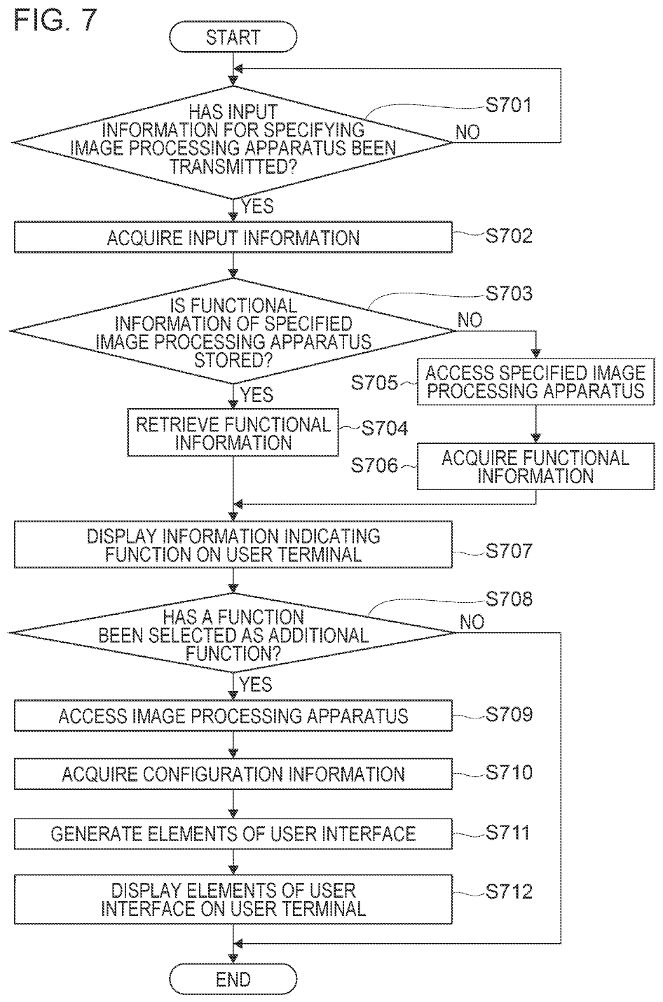

FIG. 7 is a flowchart illustrating an example of a process flow of the management server 10.

When input information for specifying an image processing apparatus 50 is transmitted from the user terminal 30 (YES in step 701), the management server 10 acquires the transmitted input information (step 702). In contrast, when input information for specifying one image processing apparatus 50 is not transmitted (NO in step 701), the management server 10 repeats the determination process in step 701 until the input information for specifying one image processing apparatus 50 is transmitted.

When the functional information of an image processing apparatus 50 specified by a user is stored (YES in step 703), the management server 10 retrieves the functional information of the image processing apparatus 50 (step 704), and displays, on the user terminal 30, the information indicating one or more functions provided by the image processing apparatus 50 (step 707). In contrast, when the functional information of the specified image processing apparatus 50 is not stored in the functional DB 131 (NO in step 703), the management server 10 accesses the specified image processing apparatus 50 (step 705) based on the input information acquired in step 702, acquires the functional information (step 706), and displays, on the user terminal 30, the information indicating the functions provided by the image processing apparatus 50 (step 707).

When one function as an additional function is selected from one or more functions displayed on the user terminal 30 and provided by the image processing apparatus 50 (YES in step 708), the management server 10 accesses the image processing apparatus 50 (step 709), and acquires the configuration information of the selected function (step 710). The management server 10 then generates the elements of user interface displayed on the user terminal 30 based on the acquired configuration information (step 711), and displays the generated elements of user interface on the user terminal 30 (step 712). In contrast, when one function as an additional function is not selected (NO in step 708), the process of the management server 10 is completed (END).

### SPECIFIC EXAMPLES

### (Specific Examples of User Interface Displayed on User Terminal)

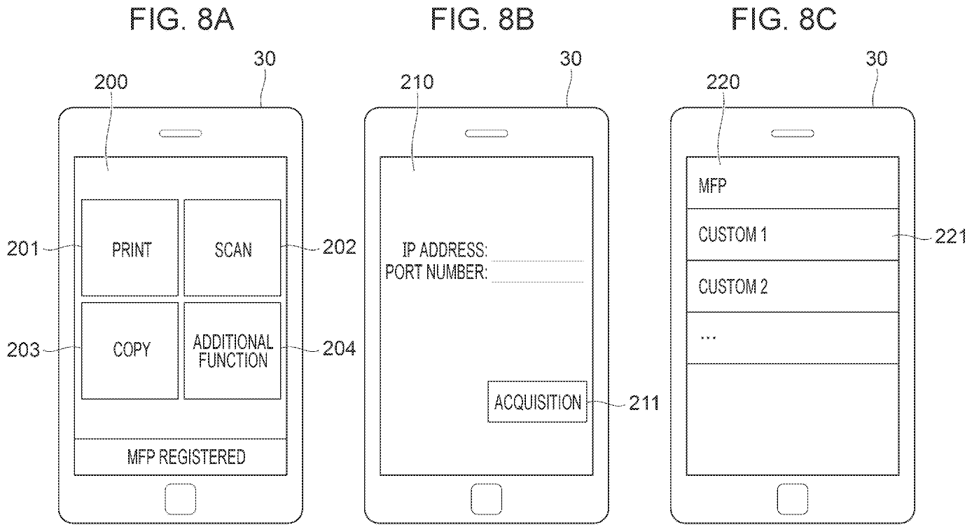

FIGS. 8A to 8C are views illustrating specific examples of user interface displayed on the user terminal 30. FIG. 8A is a view illustrating a specific example of a top screen to be displayed when an application software that enables an operation of the image processing apparatus 50 is started. FIG. 8B and FIG. 8C are views illustrating a specific example of a screen to be displayed when an additional function button 204 displayed on the screen of FIG. 8A is depressed.

When an application software that enables an operation of the image processing apparatus 50 is started from the user terminal 30, a top screen 200 illustrated in FIG. 8A is displayed. On the top screen 200, a button 201 labeled with “PRINT”, a button 202 labeled with “SCAN”, and a button 203 labeled with “COPY” are displayed. Each of these buttons 201 to 203 is a button to be depressed when a basic function of the image processing apparatus 50 is utilized. On the top screen 200, in addition to these buttons, an additional function button 204 labeled with “ADDITIONAL FUNCTION” is displayed.

The additional function button 204 is a button to be depressed when a button (hereinafter referred to as a custom button) for utilizing a function other than the functions shown by the buttons 201 to 203 is added to the top screen 200. The label “MFP REGISTERED” indicates that an MFP (multifunction printer) as the image processing apparatus 50 is already registered. When the additional function button 204 is depressed with an MFP (multifunction printer) registered, a transition is made from the top screen 200 to screen 220 illustrated in FIG. 8C. In contrast, when the additional function button 204 is depressed with an MFP (multifunction printer) not registered, a transition is made from the top screen 200 to screen 210 illustrated in FIG. 8B.

When an MFP (multifunction printer) is not already registered, a user inputs, to the screen 210, an IP address and a port number necessary for acquisition of the configuration information of the additional function, and depresses the button 211 labeled with “ACQUISITION”. Consequently, information necessary for registration is acquired, and the MFP (multifunction printer) is registered. When the MFP (multifunction printer) is registered, a transition is made from the screen 210 to the screen 220. Note that information acquired as the information necessary for registration is assumed to include the functional information of the MFP (multifunction printer).

Of the one or more functions provided by already registered MFP (multifunction printer), a list of functions operable with the user terminal 30 is displayed on the screen 220. In the example of FIG. 8C, the functions such as “CUSTOM 1”, “CUSTOM 2” are displayed as a list. A user is assumed to select the additional function 221 labeled with “CUSTOM 1”, for example. Then, the configuration information of “CUSTOM 1” as an additional function is acquired, and an UI element table is generated based on the configuration information.

### (UI Element Table and Specific Examples of User Interface)

FIGS. 9A to 9C are views illustrating specific examples of a generated UI element table and user interface. FIG. 9A is a view illustrating a specific example of information stored in the UI element table. FIG. 9B is a view illustrating a specific example of user interface which reflects the information stored in the UI element table. FIG. 9C is a view illustrating a state after a custom button is added to the top screen 200.

As described above, the UI element table is a table that is generated based on the configuration information, and stores various information that defines the elements of user interface. For example, as illustrated in FIG. 9A, the UI element table stores information on each of items: “FUNCTION NO”, “UI COMPONENT”, “DISPLAY NAME”, “x COORDINATE”, “y COORDINATE”, and “OPERATION WHEN TAPPED”.

Of the items of the UI element table, the “FUNCTION NO” is identification information for the elements of user interface, and represented by the value of 1 to m (m is an integer value greater than or equal to one). In addition, the “UI COMPONENT” is information indicating a type of element of user interface. For example, “Text” “Spinner” and “Button” indicate text data, spinner, and button, respectively. Also, the “DISPLAY NAME” is information indicating the content of a label displayed on the screen, and the “x COORDINATE” and the “y COORDINATE” provide information that defines the arrangement on the screen. Also, the “OPERATION WHEN TAPPED” is information indicating the content of action at the time of operation.

FIG. 9B illustrates custom screen 230 as a user interface generated based on the information stored in the UI element table. When the custom screen 230 is produced, the custom screen 230 is stored in association with a corresponding MFP (multifunction printer), and custom button 205 is added to the top screen. FIG. 9C illustrates a specific example of the top screen 200 after the custom button 205 is added. Afterward, when the custom button 205 is depressed with an MFP (multifunction printer) selected, the configuration information is not acquired again, and the custom screen 230 in FIG. 9B is displayed.

### (Specific Examples of Function Table)

FIGS. 10A to 10D are views illustrating specific examples of a function table. FIG. 10A is a view illustrating a specific example of information stored in the function table. FIGS. 10B to 10D are views illustrating displayed top screens which vary with the type of a selected image processing apparatus 50.

Even when a plurality of image processing apparatuses 50 are registered, the top screen displayed as a user interface of the user terminal 30 may be displayed as one common screen. However, there may be an additional function which varies with the type of the image processing apparatus 50 although the names labeled on custom buttons are the same. In such a case, a plurality of custom buttons with the same labeled name are arranged on the common top screen, thus a user may not be able to identify which custom button corresponds to which image processing apparatus 50.

In contrast, in this exemplary embodiment, a function table is generated, and each image processing apparatus 50 and its additional functions are associated with each other, thus a top screen corresponding to the image processing apparatus 50 selected by a user is designed to be displayed. FIG. 10A illustrates a specific example of a generated function table. For example, “MFP1” as the image processing apparatus 50 is associated with “CUSTOM 1”, “CUSTOM 2”, and “CUSTOM 4” as the additional functions. Also, “MFP2” is associated with “CUSTOM 1”, and “CUSTOM 3” as the additional functions. In addition, “MFP3” is associated with “CUSTOM 1” as the additional function.

Thus, when “MFP1” is selected on the user terminal 30, as illustrated in FIG. 10B, custom button 251 labeled with “CUSTOM 1”, custom button 252 labeled with “CUSTOM 2”, and custom button 253 labeled with “CUSTOM 3” are displayed on the top screen. Also, when “MFP2” is selected on the user terminal 30, as illustrated in FIG. 10C, custom button 254 labeled with “CUSTOM 1”, and custom button 255 labeled with “CUSTOM 3” are displayed on the top screen. Also, when “MFP3” is selected on the user terminal 30, as illustrated in FIG. 10D, custom button 256 labeled with “CUSTOM 1” is displayed on the top screen. In other words, only those functions available in the image processing apparatus 50 selected by a user are displayed.

### OTHER EXEMPLARY EMBODIMENTS

Although the exemplary embodiment has been described above, the present disclosure is not limited to the exemplary embodiment described above. In addition, the effects achieved by the present disclosure are not limited to those described in the exemplary embodiment above. For example, each of the configuration of the information processing system 1 illustrated in FIG. 1, the hardware configuration of the management server 10 illustrated in FIG. 2, and the hardware configuration of the image processing apparatus 50 illustrated in FIG. 3 is only an illustration to achieve the object of the present disclosure, and is not particularly limited. Also, the functional configuration of the management server 10 illustrated in FIG. 4, the functional configuration of the user terminal 30 illustrated in FIG. 5, and the functional configuration of the image processing apparatus 50 illustrated in FIG. 6 are only an illustration, and not particularly limited. It is sufficient that the function that enables the above-described processes to be executed in its entirety be provided by the information processing system 1 of FIG. 1, and the functional configurations to be used to implement this function are not limited to the examples in FIG. 4 to FIG. 6.

Also, the order of steps of the process performed by the management server 10 illustrated in FIG. 7 is only an illustration, and not particularly limited. The process is not only performed in time series in the order of the illustrated steps. The process is not necessarily performed in time series, and may be performed concurrently or individually. In addition, the specific examples illustrated in FIGS. 8A-8C to FIGS. 10A-10D are only one example, and not particularly limited.

For example, in the above-described specific example illustrated in FIGS. 8A to 8C, it is the assumption that information acquired as the information necessary for registration includes the functional information of an MFP (multifunction printer), but is not limited thereto. In the case where the information acquired as the information necessary for registration includes the functional information of an MFP (multifunction printer), for example, when the additional function button 204 labeled with “ADDITIONAL FUNCTION” illustrated in FIG. 8A is depressed, a screen is displayed, which includes a message such as “PLEASE TAP TO ACQUIRE AVAILABLE ADDITIONAL FUNCTION”, and a button for instructing addition of functional information including the additional function, and after the functional information is added, a transition may be made to the screen of FIG. 8C.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
one or a plurality of processors configured to:
   cause a terminal for operating an image processing apparatus to display one or more functions provided by the image processing apparatus in a selectable manner;
   acquire, from the image processing apparatus, configuration information on configuration for performing an operation to utilize a function with the terminal, the function being selected by a user from the displayed one or more functions; and
   generate elements of user interface to be displayed on the terminal, based on the acquired configuration information.
      (((2)))

The information processing system according to (((1))),
wherein the one or a plurality of processors is configured to:
   manage information on one or more functions provided by each of one or more image processing apparatuses, each of which is the image processing apparatus; and
   display the one or more functions provided by an image processing apparatus on the terminal in a selectable manner, the image processing apparatus being specified by the user from the one or more image processing apparatuses.
      (((3)))

The information processing system according to (((2))),
wherein the one or a plurality of processors is configured to as an operation for specifying the image processing apparatus by the user, receive an operation for inputting identification information by which the image processing apparatus is uniquely identifiable.
   (((4)))

The information processing system according to (((2))) or (((3))),
wherein the one or a plurality of processors is configured to:
   generate a table for defining aspects of the elements of user interface based on the acquired configuration information; and manage the aspects of the elements of user interface by the generated table.
      (((5)))

The information processing system according to (((4))),
wherein the table includes at least one piece of information among pieces of information on type, label, arrangement, and operation for each of the elements of user interface.
   (((6)))

The information processing system according to any one of (((2))) to (((5))),
wherein the one or a plurality of processors is configured to:
   manage the image processing apparatus specified by the user, and the generated elements of user interface in association with each other; and
   upon specification of the image processing apparatus again by the user, cause the terminal to display the elements of user interface associated with the image processing apparatus.
      (((7)))

The information processing system according to any one of (((2))) to (((6))),
wherein the one or a plurality of processors is configured to generate a table that associates the image processing apparatus specified by the user with the function selected by the user, and store the table in the terminal.
   (((8)))

The information processing system according to (((7))),
wherein the one or a plurality of processors is configured to:
   retrieve, from the table, one or more functions associated with the image processing apparatus specified by the user; and
   cause the terminal to display the elements of user interface, which indicate each of the retrieved one or more functions.
      (((9)))

A program causing a computer to execute a process comprising:
causing a terminal for operating an image processing apparatus to display one or more functions provided by the image processing apparatus in a selectable manner;
acquiring, from the image processing apparatus, configuration information on configuration for performing an operation to utilize a function with the terminal, the function being selected by a user from the displayed one or more functions; and
generating elements of user interface to be displayed on the terminal, based on the acquired configuration information.

What is claimed is:

1. An information processing system comprising:
one or a plurality of processors configured to:
cause a terminal for operating an image processing apparatus to display one or more functions provided by the image processing apparatus in a selectable manner;
acquire, from the image processing apparatus, configuration information on configuration for performing an operation to utilize a function with the terminal, the function being selected by a user from the displayed one or more functions; and
generate elements of user interface to be displayed on the terminal, based on the acquired configuration information.

2. The information processing system according to claim 1,
wherein the one or a plurality of processors is configured to:
manage information on one or more functions provided by each of one or more image processing apparatuses, each of which is the image processing apparatus; and
display the one or more functions provided by an image processing apparatus on the terminal in a selectable manner, the image processing apparatus being specified by the user from the one or more image processing apparatuses.

3. The information processing system according to claim 2,
wherein the one or a plurality of processors is configured to:
as an operation for specifying the image processing apparatus by the user, receive an operation for inputting identification information by which the image processing apparatus is uniquely identifiable.

4. The information processing system according to claim 2,
wherein the one or a plurality of processors is configured to:
generate a table for defining aspects of the elements of user interface based on the acquired configuration information; and
manage the aspects of the elements of user interface by the generated table.

5. The information processing system according to claim 4,
wherein the table includes at least one piece of information among pieces of information on type, label, arrangement, and operation for each of the elements of user interface.

6. The information processing system according to claim 2,
wherein the one or a plurality of processors is configured to:
manage the image processing apparatus specified by the user, and the generated elements of user interface in association with each other; and
upon specification of the image processing apparatus again by the user, cause the terminal to display the elements of user interface associated with the image processing apparatus.

7. The information processing system according to claim 2,
wherein the one or a plurality of processors is configured to generate a table that associates the image processing apparatus specified by the user with the function selected by the user, and store the table in the terminal.

8. The information processing system according to claim 7,
wherein the one or a plurality of processors is configured to:
retrieve, from the table, one or more functions associated with the image processing apparatus specified by the user; and
cause the terminal to display the elements of user interface, which indicate each of the retrieved one or more functions.

9. A non-transitory computer readable medium storing a program causing a computer to execute a process comprising:
causing a terminal for operating an image processing apparatus to display one or more functions provided by the image processing apparatus in a selectable manner;
acquiring, from the image processing apparatus, configuration information on configuration for performing an operation to utilize a function with the terminal, the function being selected by a user from the displayed one or more functions; and
generating elements of user interface to be displayed on the terminal, based on the acquired configuration information.

10. An information processing method comprising:
causing a terminal for operating an image processing apparatus to display one or more functions provided by the image processing apparatus in a selectable manner;
acquiring, from the image processing apparatus, configuration information on configuration for performing an operation to utilize a function with the terminal, the function being selected by a user from the displayed one or more functions; and
generating elements of user interface to be displayed on the terminal, based on the acquired configuration information.
